(19) United States
(12) Patent Application Publication
(10) Pub. No.: US 2009/0051463 A1
(43) Pub. Date: Feb. 26, 2009

(54) SPLITTER/COMBINER CIRCUIT

(75) Inventor: Clyde Maynord Callewaert, Shelby Township, MI (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 12/184,655

(22) Filed: Aug. 1, 2008

Related U.S. Application Data
(63) Continuation-in-part of application No. 11/599,541, filed on Nov. 14, 2006.
(60) Provisional application No. 60/782,387, filed on Mar. 15, 2006.
(60) Provisional application No. 60/830,971, filed on Jul. 14, 2006.

(51) Int. Cl. H01P 5/12

(52) U.S. Cl. 333/134

(57) ABSTRACT

A circuit for combining/splitting at least two RF signals comprising: (a) at least two or more transmission portions coupled at an intersection, the intersection having a common port for inputting or outputting a combination of the at least two RF signals; (b) each transmission portion extending from the intersection to a port for inputting or outputting a selection of signals from the combination, and comprising at least one set of intersecting transmission lines; (c) each set of intersecting transmission lines rejecting a particular signal of the combination; and (d) each intersecting transmission line of a given set having a length of about an odd multiple of a quarter wavelength of the particular signal which is rejected by the given set.

### CROSS REFERENCE

This application claims priority to U.S. Provisional Application No. 60/782,387, filed Mar. 15, 2006, U.S. Provisional Application No. 60/830,971, filed Jul. 14, 2006, and U.S. patent application Ser. No. 11/599,541, which are hereby incorporated herein by reference.

### FIELD OF INVENTION

The present invention relates to circuitry for combining/splitting different wavelength signals and, more specifically, to a radio frequency (RF) signal diplexer for use with multifunction antennas.

### BACKGROUND OF INVENTION

The proliferation of vehicular wireless communication services continues to challenge both original equipment manufacturers (OEMs) and their suppliers to innovate cost effective antenna solutions. Specifically, these emerging services operate on a wide range of frequencies and thus necessitate the development of multiband antenna systems to mitigate cost and improve esthetics. Optimal solutions provide multiband operation by clever consolidation of multiple antennas into a single unit.

An automotive telematics antenna, which combines AMPS (American Mobile Phone Standard), PCS (Personal Communication Service) and GPS (Global Positioning System) services into a single unit, is an example of a consolidated multiband antenna. Moreover, the recent addition of Satellite Digital Audio Radio System, SDARS, has prompted the development of a quad-band antenna adding SDARS to telematics functions.

While these multiband antennas offer many advantages to OEM's, they nevertheless require dedicated coaxial cables for each function. The additional coaxial cables impact routing, location options, increase hole diameter for roof-mounted applications while increasing cost and complexity.

Therefore, there is a need to combine functions onto fewer coaxial cables to reduce the number of cables used. For example, the elimination of even one coaxial cable is significant as it means an OEM can save typically three (3) meters of coaxial cable per vehicle. The present invention fulfills this need among others.

### SUMMARY OF INVENTION

One aspect of this invention is a circuit for combining/splitting at least two RF signals by relying on their different propagation characteristics in the circuit. In one embodiment, the circuit comprises: (a) at least two or more transmission portions coupled at an intersection, the intersection having a common port for inputting or outputting a combination of the at least two RF signals; (b) each transmission portion extending from the intersection to a port for inputting or outputting a selection of signals from the combination, and comprising at least one set of intersecting transmission lines; (c) each set of intersecting transmission lines rejecting a particular signal of the combination; and (d) each intersecting transmission line of a given set having a length of about an odd multiple of a quarter wavelength of the particular signal which is rejected by the given set.

In another embodiment, the circuit of the present invention combines/splits at least three signals having different wavelengths x, y, z and comprises: (a) at least first and second transmission portions coupled at an intersection, the first transmission portion comprising at least two sets of intersecting transmission lines, a first set having two intersecting transmission lines, each having a length which is an odd multiple of about ¼ y, a second set having two intersecting transmission lines, each having a length which is an odd multiple of about ¼ z, the second transmission portion comprising at least two intersecting transmission lines, each having a length which is an odd multiple of about ¼ x; and (b) first, second and third ports, the first port located at the first transmission portion, the second port located at the intersection of the first and second transmission portions, and the third port being located at the second transmission portion.

### BRIEF DESCRIPTION OF DRAWINGS

FIG. 1 shows a printed diplexer layout of the present invention.

FIG. 2 shows circuit simulator results for the layout of FIG. 1, indicating equal insertion loss of 0.22 dB at markers 1 at 1.575 GHz and 2 at 2.333 GHz.

FIG. 3 shows circuit simulator results for the layout of FIG. 1, indicating VSWR vs. frequency.

FIG. 4 shows finite element method (FEM) simulation results for the layout of FIG. 1, indicating equal insertion loss of 0.27 dB at markers 1 at 1.575 GHz and 2 at 2.333 GHz.

FIG. 5 shows FEM simulation results for the layout of FIG. 1, indicating VSWR vs. frequency.

FIG. 6 shows a circuit current distribution for the layout of FIG. 1 at 1.575 GHz showing S23 transmission.

FIG. 7 shows a circuit current distribution for the layout of FIG. 1 at 2.333 GHz showing S21 transmission.

FIG. 8 shows an alternative printed diplexer layer of the present invention.

FIG. 9 shows circuit simulator results for the layout of FIG. 8, indicating insertion loss at markers 1 at 1.575 GHz and 2 at 2.333 GHz.

FIGS. 10-13 show other characteristics relating to the printed diplexer illustrated in FIG. 8.

FIG. 14 shows an alternative embodiment of the circuit of the present invention.

FIG. 15 shows insertion loss for a circuit simulation.

FIG. 16 shows return loss for a circuit simulation.

FIG. 17 shows insertion loss according to a finite element simulation.

FIG. 18 shows return loss according to a finite element simulation.

FIG. 19 shows an alternative embodiment of the circuit of the present invention.

### DETAILED DESCRIPTION OF EMBODIMENTS

The present invention provides a circuit that combines/splits signals of different wavelengths by relying on their different propagation characteristics in the circuit. Specifically, the circuit comprises two or more adjoining portions with a port located in each portion, and a common port at the junction of the two or more portions. Each portion performs two functions. First, it functions to couple its port with the common port for one signal, and, second, it functions to establish high impedance upon introduction of the other signals. Preferably, the portion establishes high impedance by forming a standing wave of the other signals, which significantly reduces the other signals' ability to propagate within the portion and reach its port. Each portion therefore is configured to couple one signal port-to-port, but to reflect the other signals. Preferably, this dual functionality is achieved passively with little or no discrete components such as filters that can introduce significant insertion loss to the circuit.

Therefore, the circuit of the present invention is designed such that, rather than selectively pass band filtering a combination of signals, such as, SDARS and GPS, or AMPS, PCS and GPS, on their respective branches, the circuit rejects the unwanted band by presenting high impedance at the common port, making the circuit appear as a “two port” through for each signal.

This circuit provides a number of important benefits. First, it provides an elegant solution to combine two or more signals on a given line, thereby reducing the number coaxial cables used in automotive antenna applications. Second, since it preferably does not use discrete components, its insertion loss tends to be lower than that of traditional splitter/combiner circuits. Third, the circuit may comprise print-distributed elements, which are very precise, yet relatively inexpensive to produce in high volume. Still other benefits will become apparent to those of skill in the art in light of this disclosure.

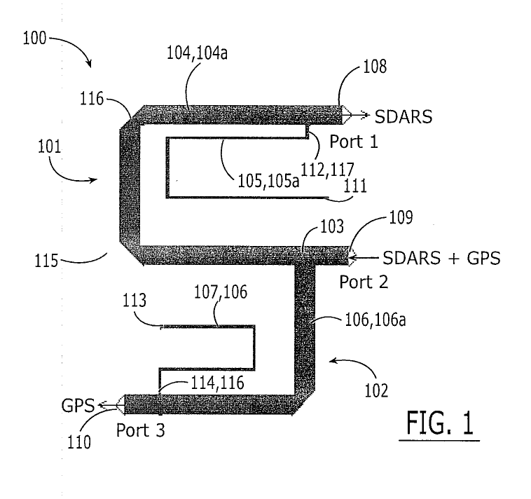

Referring to FIG. 1, one embodiment of a circuit 100 for combining/splitting a combination of RF signals, first and second signals, having different wavelengths of x and y, respectively, is shown.

It should be understood that the “wavelength” as used herein refers to the guided wavelength in the transmission line as opposed to a “free space” wavelength. The term “transmission line” is used broadly and collectively to refer to any known transmission line or waveguide. Preferably, the transmission line is a known transmission line such as, for example, a microstrip, a grounded coplanar waveguide, or a strip line. More preferably, the transmission line is a microstrip for ease of manufacturing (e.g., printing) and compactness.

The circuit 100 comprises first and second transmission portions 101, 102, coupled at an intersection 103. As mentioned above, each portion serves two functions—it provides a port-to-port connection for one signal while presenting high impedance for the other signals. In this embodiment, the first portion provides a port-to-port connection for the first signal and presents high impendence for the second signal. To present high impedance, the first transmission portion 101 comprises at least two transmission lines 104, 105, which intersect at intersection 117. Each transmission line has a length which is an odd multiple of about ¼ y. More specifically, the transmission line 104 which runs from intersection 103 to intersection 117, and the transmission line 105, which runs from intersection 117 to free end 111, have a length which is about an odd multiple of a quarter wavelength of wavelength y. As used herein, an “odd multiple” refers to the product of odd integers (e.g., 1, 3, 5, etc.) and the quarter wavelength of a given wavelength. For example, the odd multiple of ¼ y include ¼ y, ¾ y, 1¼ y, etc. As discussed below, by configuring the transmission lines in this way, a standing wave for the second signal is generated.

The second transmission portion 102 also comprises at least two transmission lines 106, 107, which interest at intersection 116. Similar to the first portion described above, the transmission line 106 which runs from intersection 103 to intersection 116, and the transmission line 107, which runs from intersection 116 to free end 113, have a length which is about an odd multiple of a quarter wavelength of wavelength x.

The circuit 100 also comprises first, second and third ports 108, 109, 110. The first port 108 is located at the distal end of the first transmission portion 101, the second port 109 located at the intersection 103 of the first and second transmission portions 101, 102, and the third port 110 being located at the distal end of the second transmission portion 102. Preferably, there are no filters along the coupling between the first and second ports and the second and third ports.

The circuit 100 may also be described in terms of a given transmission portion and the particular intersecting transmission lines signals it comprises for preventing particular signals from propagating along that portion. Specifically, referring to FIG. 1, the circuit 100 can be used combining/splitting at least two RF signals, each having a different wavelength. In this embodiment, the circuit is configured for two RF signals, first and second signals, having wavelengths x and y, respectively.

The circuit 100 comprises at least two or more transmission portions 101, 102 coupled at an intersection 103. The intersection has a common (second) port 109 for inputting or outputting the first and second signals. Each transmission portion 101, 102 extends from the intersection 103 to a port for inputting or outputting a selection of signals from the combination. In the embodiment, the first transmission portion extends to the first port 108, which inputs/outputs the first signal, and the second transmission portion extends to the third port 110, which inputs/outputs the second signal. Each transmission portion also comprises at least one set of intersecting transmission lines, which, in this embodiment, are 104, 105 for the first transmission portion 101, and 106, 107 for the second transmission portion 102.

Each set of intersecting transmission lines rejects a particular signal of the combination. For example, in this embodiment, intersecting transmission lines 104, 105 reject the second signal and intersecting transmission lines 106, 107 reject the first signal. Each intersecting transmission line of a given set has a length of about an odd multiple of a quarter wavelength of the particular signal which is rejected by the given set. In this embodiment, the each of the intersecting transmission lines 104, 105 are an odd multiple of a quarter wavelength of the second signal wavelength y, and each of the intersecting transmission lines 106, 107 are an odd multiple of a quarter wavelength of the first signal wavelength x.

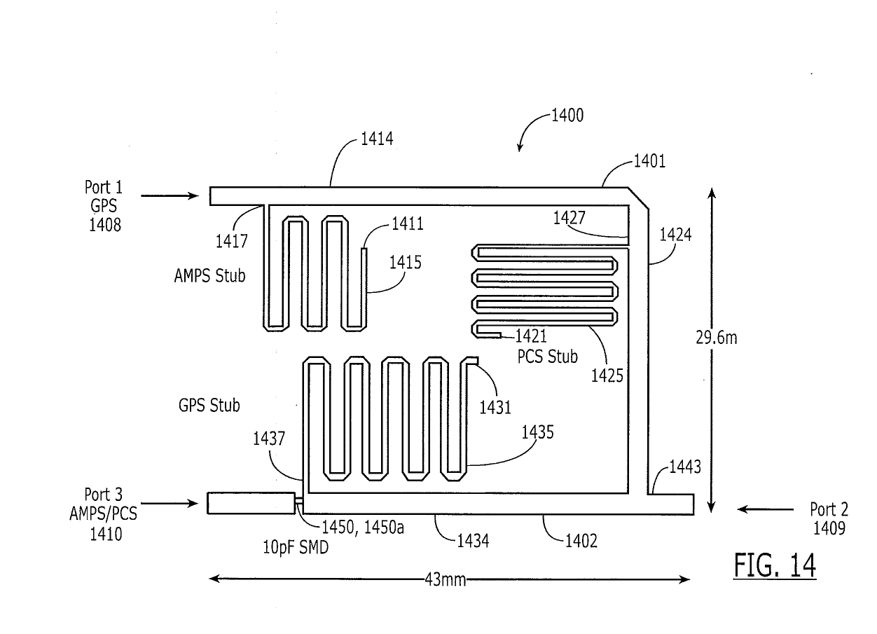

Although FIG. 1 was described in terms of just two RF signals, the circuit may contain three or more signals as described below with respect to FIG. 14.

As mentioned above, each transmission portion 101, 102 serves two purposes. The first and relatively straight-forward purpose is to couple the port of the transmission portion to the common or second port for a particular signal. The other purpose is more complex and requires the transmission portion to establish high impedance upon introduction of the other signal. Preferably, the transmission portion establishes high impedance by forming a standing wave of the other signal. This high impedance reflects the other signal or otherwise significantly reduces its ability to propagate within the transmission portion and reach the port within. Each transmission portion therefore is configured to couple one signal port-to-port, but reflect the other signal.

Although different techniques and configurations can be used to perform the dual function of coupling one frequency and reflecting another, preferably this is accomplished with no discrete or lumped components. That is, in a preferred embodiment, the coupling and reflective properties of the transmission portion is dictated largely, if not entirely, by the geometry and configuration of transmission lines within the transmission portion.

Applicant recognizes that the circuit can be configured to exploit the wavelength difference between the signals such that it behaves differently for one signal than it does for another. To this end, applicant has configured the circuit to create a standing wave at one frequently but allow the other signal to pass. It is well known that a standing wave will reflect any signal having approximately the same or odd multiples of the same wavelength. The standing wave is created preferably by creating an interruption point along the transmission path. The interruption point is preferably the junction of the main transmission line and a stub transmission line. The lengths of the main and stub transmission lines are an odd multiple of about ¼ the wavelength to be reflected.

More specifically, referring to FIG. 1, the two intersecting transmission lines of the first transmission portion comprise at least a first transmission line 104a and a first stub transmission line 105a having a free end 111 and a connected end 112. The first port 108 is disposed at one end of the first transmission line 104a and the second port 109 is disposed at the other end of the first transmission line 104a. The connected end 112 of the first stub transmission line 105a is connected to the first transmission line 104a proximate the first port 108. Likewise, the at least two intersecting transmission lines of the second transmission portion comprises at least a second transmission line 106a, and a second stub transmission line 107a having a free end 113 and a connected end 114. The third port 110 is disposed at one end of the second transmission line 106a and the second port 109 is disposed at the other end of the second transmission line 106a. The connected end 114 of the second stub transmission line 107a is connected to the second transmission line 106a proximate the third port 110.

It should be understood that, from a practical standpoint, the ability of the transmission portion to couple one frequency while creating a standing wave for the other will likely be more of an optimization/compromise than an absolute. That is, it is unlikely that the wavelengths of the two signals will be related by a ½ multiple—e.g., y is an odd multiple of ½ x—as is required for a perfect circuit in which the coupling of one signal and the reflection of the other will be theoretically absolute. Rather, the circuit 100 is likely to strike a compromise between coupling and reflecting based on the relative importance of the desired insertion loss and isolation. In other words, if high isolation is desired over insertion loss, the transmission portion may be configured to efficiently create a standing wave for one signal even though it may also interrupt the propagation of the signal too. On the other hand, if low insertion loss is more important, than the circuit may be designed to efficiently couple one signal, while only partially reflecting the other signal. This optimization will of course depend upon the application and one skilled in the art can readily optimize the circuit using known optimization and simulation techniques and tools to create the desired performance.

Since the lengths of the transmission lines will therefore likely be adjusted from theoretical values to optimize insertion and isolation parameters, the two intersecting transmission lines 104, 105 and 106, 107 will not typically have a length which is a precise multiple of ¼ y and ¼ x, respectively. Rather, they will have a length that is “about” an odd multiple of ¼ y and ¼ x. The term “about” therefore is used in this context to indicate that this is not likely a precise multiple but rather an optimized/compromised number to strike a balance between coupling efficiency of one signal and isolation of the other. Generally, about ¼ y and about ¼ x is ¼ y±<⅛y and ¼ x±<⅛ x, respectively, preferably, ¼ y±< 1/16 y and ¼ x±< 1/16 x, respectively, and, more preferably, ¼ y±< 1/32 y and ¼ x±< 1/32 x, respectively.

In a particularly preferred embodiment, the circuit 100 comprises: (a) a substrate 115; (b) first and second transmission lines 104, 106 intersecting on the substrate; (c) first, second and third ports 108, 109, 110 on the substrate 115, the first port 108 disposed at one end of the first transmission line 105a, the second port 109 being disposed at the intersection 103 of the first and second transmission lines 104a, 106a, the third port 110 being disposed at the end of the second transmission line 106a; (d) first and second stub transmission lines 105a, 107a on the substrate 115, each having a free end 111, 113 and a connected end, 112, 114, the connected end 112 of the first stub transmission line 105a being connected to the first transmission line 104a proximate the first port 108, the connected end 114 of the second stub transmission line 107a being connected to the second transmission line 106a proximate to the third port 110; and (e) wherein the first transmission line and the first stub transmission line have lengths which are an odd multiple of about ¼ y±<⅛ y, the second transmission line and the second stub transmission line having a length which is an odd multiple of ¼ x+<⅛ x.

The transmission lines may be configured for compactness. That is, rather than having essentially straight lines, it may be preferable to “fold” the lines to fit the circuit in a smaller package. For example, referring to FIG. 1, both the main and stub transmission-lines are folded such that portions of each line are angled to one another. Specifically, the first transmission line 104a is folded in a U shape and the second transmission line 106a is folded in an L shape. Both stub transmission lines are folded in essentially U shapes. By folding the lines in this matter, the entire circuit fits into a smaller form factor. Although folding the transmission lines will make the circuit more compact, it should be recognized that angles in the lines tend to create loss. Therefore, it is desirable to minimize the number of bends. Further, it is preferable to chamfer the corners as shown in FIG. 1 to minimize losses. Such techniques are known in the art.

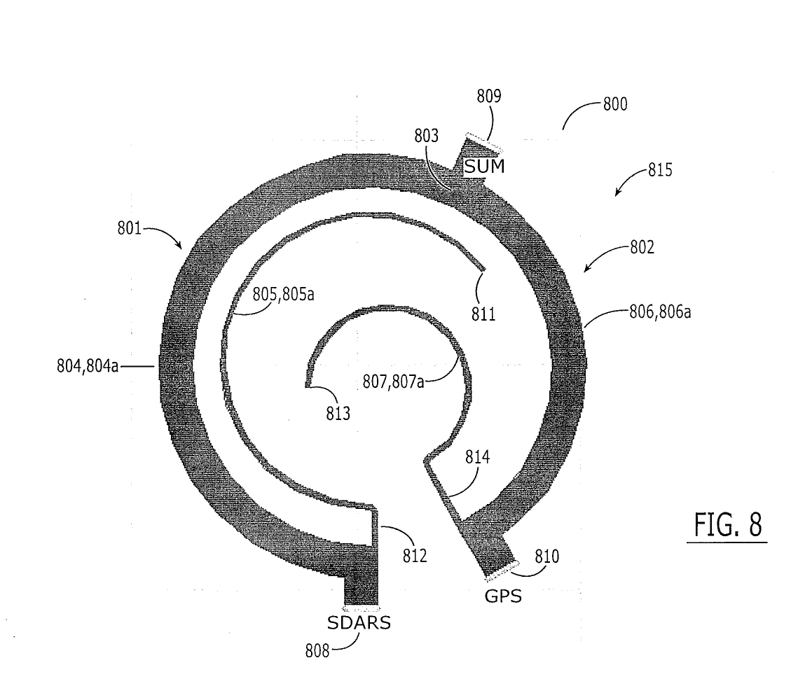

Moreover, in addition to being folded as shown in FIG. 1, the transmission lines can be made other shapes in an effort to provide compactness. For example, as illustrated in FIG. 8, a curved splitter/combiner is provided.

Referring to FIG. 8, a circuit 800 for combining/splitting first and second RF signals having different wavelengths of x and y, respectively, is shown. The circuit 800 comprises: (a) first and second transmission portions 801, 802, coupled at an intersection 803, the first transmission portion 801 comprising at least two intersecting transmission lines 804, 805, each having a length that is an odd multiple of about ¼ y, the second transmission portion 802 comprising at least two intersecting transmission lines 806, 807, each having a length which is an odd multiple of about ¼ x; and (b) first, second and third ports 808, 809, 810, the first port 808 located at the first transmission portion 801, the second port 809 located at the intersection 803 of the first and second transmission portions 801, 802, and the third port 810 being located at the second transmission portion 802, the first and second ports 808, 809 being electrically coupled, and the second and third ports 809, 810 being electrically coupled

More specifically, the two intersecting transmission lines of the first transmission portion comprise at least a first transmission line 804a and a first stub transmission line 805a having a free end 811 and a connected end 812. The first port 808 is disposed at one end of the first transmission line 804a and the second port 809 is disposed at the other end of the first transmission line 804a. The connected end 812 of the first stub transmission line 805a is connected to the first transmission line 804a proximate the first port 808. Likewise, the two intersecting transmission lines of the second transmission portion comprises at least a second transmission line 806a, and a second stub transmission line 807a having a free end 813 and a connected end 814. The third port 810 is disposed at one end of the second transmission line 806a and the second port 809 is disposed at the other end of the second transmission line 806a. The connected end 814 of the second stub transmission line 807a is connected to the second transmission line 806a proximate the third port 810.

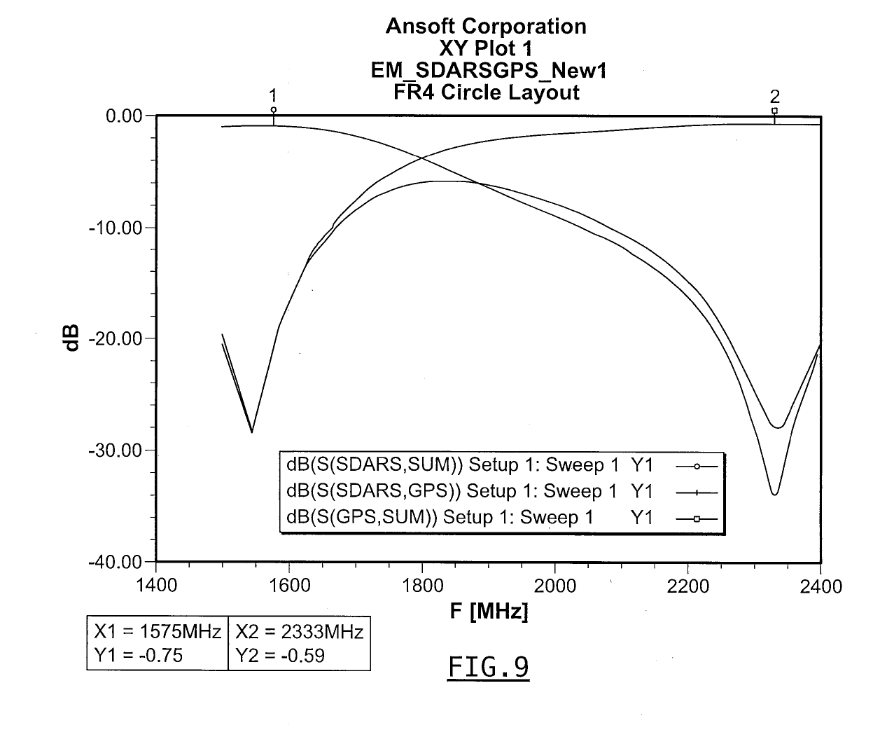

In a particularly preferred embodiment, the circuit 800 comprises: (a) a substrate 815; (b) first and second transmission lines 804, 806 intersecting on the substrate; (c) first, second and third ports 808, 809, 810 on the substrate 815, the first port 808 disposed at one end of the first transmission line 804a, the second port 809 being disposed at the intersection 803 of the first and second transmission lines 804a, 806a, the third port 810 being disposed at the end of the second transmission line 806a; (d) first and second stub transmission lines 805a, 807a on the substrate 815, each having a free end 811, 813 and a connected end, 812, 814, the connected end 812 of the first stub transmission line 805a being connected to the first transmission line 804a proximate the first port 808, the connected end 814 of the second stub transmission line 807a being connected to the second transmission line 806a proximate to the third port 810; and (e) wherein the first transmission line and the first stub transmission line have lengths which are an odd multiple of about ¼ y±<⅛ y, the second transmission line and the second stub transmission line having a length which is an odd multiple of ¼ x±<⅛ x. FIGS. 9-13 provide additional simulation analysis of the FIG. 8 splitter/combiner. One could also readily appreciate that other curved splitter/combiners shapes are within the scope of the invention including but not limited to ovals, ellipses, and rounded rectilinear shapes.

It should be understood that, although the embodiments of FIGS. 1 and 8 show a circuit for splitting/combining a combination of two signals, a circuit for slitting/combining more than two signals is within the scope of the invention. In this regard, each signal may have its one transmission portion for effecting its port-to-port connection, while presenting high impedance for the other signals. To generate high impedance for the other signals in a given portion, that transmission portion comprises a set of intersecting transmission lines as described above for each of the other signals. For example, if the portion is configured to provide a port-to-port connection for a first signal but generate high impedance for second and third signals, then it comprises two sets of intersecting transmission lines for the second and third signals. The intersecting transmission lines of one set are an odd multiple of a ¼ wavelength of the second signal, and the intersecting transmission lines of the other set are an odd multiple of a ¼ wavelength of the third signal. This configuration is discussed in detail below with respect to FIG. 14.

In certain situations, it may be advantages to group certain signals on common portions for the port-to-port connection. The signals may be used alternatively or the two signals may simultaneously utilize this portion of the circuit as both are passed port-to-port. For example, this portion of the circuit may be connected to a single antenna designed to operate at AMPS and PCS for vehicular cell phone applications. All cell phones have AMPS/PCS diplexers and so separating these signals is not necessary. That is, if the system using the circuit can delineate or function in the presence of one or both signals, then those signals may be grouped on a common portion. For example, referring to FIG. 14, an embodiment of three-signal splitter/combiner circuit 1400 is shown. Specifically, this embodiment combines/splits first, second, and third RF signals having different wavelengths of x, y, z respectively. This embodiment groups the second and third signals on a common portion because they are signal alternatives.

The circuit 1400 comprises first and second transmission portions 1401, 1402, coupled at an intersection 1443. The first transmission portion 1401 comprises two sets of intersecting transmission lines. The first set of intersecting transmission lines 1414, 1415 interest at intersection 1417. Accordingly, the transmission line 1414 runs from intersection 1443 to intersection 1417, and the transmission line 1415 runs from intersection 1417 to its free end 1411. The first set of intersecting transmission lines have a length which is about an odd multiple of a quarter wavelength of wavelength y.

The second set of intersecting transmission lines 1424, 1425 of the first portion 1401 intersect at intersection 1427. Accordingly, the transmission line 1424 runs from intersection 1443 to intersection 1427, and the transmission line 1425 runs from intersection 1427 to its free end 1421. The second set of intersecting transmission lines have a length which is about an odd multiple of a quarter wavelength of wavelength z. It is worthwhile to mention that portions of transmission lines 1414 and 1424 share a common transmission line. In this embodiment, transmission line 1424 is a portion of transmission line 1414.

The second transmission portion 1402 comprises one set of intersecting transmission lines 1434, 1435, which interest at intersection 1437. The transmission line 1434, which runs from intersection 1443 to intersection 1437, and the transmission line 1435, which runs from intersection 1437 to free end 1431, have a length which is about an odd multiple of a quarter wavelength of wavelength x. The transmission lines 1415, 1425, and 1435 are preferably stub transmission lines as described with respect to FIG. 1.

The circuit 1400 also comprises first, second and third ports 1408, 1409, 1410, the first port 1408 located at the first transmission portion 1401, the second port 1409 located at the intersection 1443 of the first and second transmission portions 1401, 1402, and the third port 1410 being located at the second transmission portion 1402. In one embodiment, there are no filters along the coupling between the first and second ports and the second and third ports.

The circuit 1400 may also be described in terms of a given transmission portion and the particular intersecting transmission lines signals it comprises for preventing “filtered” signals from propagating along that portion. Specifically, referring to FIG. 14, the circuit 1400 is configured for combining/splitting three RF signals, first, second and third signals, having wavelengths x, y, and z, respectively.

The circuit 1400 comprises at least two or more transmission portions 1401, 1402 coupled at an intersection 1443. The intersection has a common (second) port 1409 for inputting or outputting the first, second, and third signals. Each transmission portion 1401, 1402 extending from the intersection 1443 to a port 1408 (first port), 1410 (third port) for inputting or outputting a selection of signals from the combination. In this embodiment, the first port 1408 inputs/outputs the first signal and the third port 1410 inputs/outputs the second/third signals. Each transmission portion also comprises at least one set of intersecting transmission lines. In this embodiment, the first transmission portion comprise two sets of intersecting transmission lines 1414, 1415 and 1424, 1425, and the second transmission portion 1402 comprises one set of intersecting transmission lines 1434, 1435.

Each set of intersecting transmission lines rejects a particular signal of the combination. For example, in this embodiment, intersecting transmission lines 1414, 1415 reject the second signal, intersecting transmission lines 1424, 1425 reject the third signal, and intersecting transmission lines 1434, 1435 reject the first signal. Each intersecting transmission line of a given set has a length of about an odd multiple of a quarter wavelength of the particular signal which is rejected by the given set. In this embodiment, intersecting transmission lines 1414, 1415 are an odd multiple of a quarter wavelength of the second signal wavelength y, intersecting transmission lines 1424, 1425 are an odd multiple of a quarter wavelength of the third signal wavelength z, and intersecting transmission lines 1434, 1435 are an odd multiple of a quarter wavelength of the first signal wavelength x.

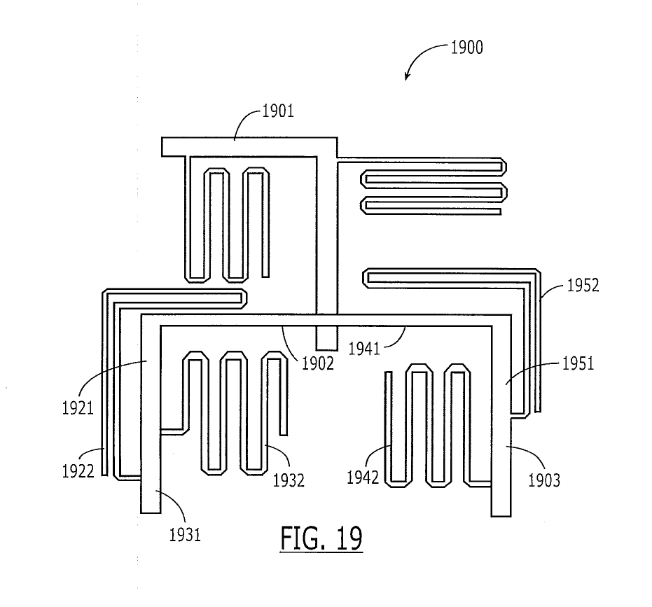

If the second and third signals were not combined on the third port 1410 of the second transmission portion 1402, a third transmission portion would be required as shown in the circuit 1900 of FIG. 19. In this embodiment, the first portion 1901 provides the port-to-port connection for the first signal, the second portion 1902 provides the port-to-port connection for the second signal, and third portion 1903 provides the port-to-port connection for the third signal. Here, the first portion 1901 is essentially the same with respect to FIG. 14, but the second portion 1902 would have two sets of intersecting transmission lines 1921, 1922 and 1931, 1932 for each wavelength it rejects or prevents from propagating. Each set of intersecting transmission lines have lengths corresponding to an odd multiple of the wavelength to be rejected. Specifically, intersecting transmission lines 1921, 1922 are an odd multiple of a quarter wavelength x, and intersecting transmission lines 1931, 1932 are an odd multiple of a quarter wavelength z. Likewise, the third portion 1903 would have two sets of intersecting transmission lines, 1941, 1942 and 1951, 1952, having lengths corresponding to an odd multiple of a quarter wavelength of x and y wavelengths, respectively.

It should be obvious to one of skill in the art in light of this specification that the splitter/combiner circuit of the present invention can be expanded to accommodate even more signals—i.e., the circuit may include four, five, or even more portions. Although as the number of signals increases so does the need for sets of intersecting transmission lines on each transmission portion to reject the unwanted signals from that transmission portion (unless signals are combined on common portion as described with respect to FIG. 14). Therefore, there may be a point of diminishing results on combining different signals on a given circuit. The point of this diminishing result, however, is likely to change as technology improves to increase the number of transmission lines within a given space.

The use of microstrip technology facilitates integration with low noise amplifies (LNA) layouts in active antenna structures. Additionally, microstrips that do not have vias are preferred in some embodiments because active automotive antennas receive power from the receiver along the coaxial cable so the diplexer must provide a DC path to each antenna's LNA.

In other embodiments, however, the antennae are not active. Specifically, although a DC path is necessary in a GPS antenna, it is not desirable in AMPS/PCS antennae. Indeed, feeding DC power to the cell phone using the AMPS/PCS signals can be detrimental to the cell phone. Accordingly, in circumstances in which the circuit must accommodate one type of signal that requires an active antenna—i.e., DC powered, and another type of signal that does not, then a capacitor can be used to block the DC power from reaching the port of the signal type that does not require power. For example, referring to FIG. 14, a capacitor 1450 is used at the end of the second portion 1402 to prevent DC power from reaching the first port. In this embodiment, the capacitor 1450 may not only block DC power from reaching the first port 1408, but also impedance match the circuit for the second and/or third signals. For example, in the embodiment, shown in FIG. 14, if the first signal corresponds to a GPS signal and the second and third correspond to AMPS/PCS signals, a 10 pfd capacitor 1450a functions to both block the DC power to port 1408 while impendence matching the circuit 1400 for AMPS signal.

Preferably, the characteristic impedance of the transmission lines is lower than that of the stub transmission lines. This way, there is a tendency for RF power to flow down the main transmission lines. For example, good results are obtained when the impedance of the transmission lines is 50Ω and that of the stub transmission lines is 120Ω. In a preferred embodiment, the higher impedance is dictated by the width of the transmission lines such that the main transmission lines are substantially wider than the stub transmission lines.

Returning to a discussion of FIG. 1, the circuit 100 (as well as circuits 800, 1400) may comprise any standard substrate known facilitating transmission of signal in the frequency range of the given application. Such materials are well known and include, for example, silicon, silicon-based materials, ceramic (e.g., aluminates), Teflon-based materials, and epoxy composites, or any other printed wire board (PWB) material. If the waveguide is a hollow waveguide, the substrate may be air.

In its use as a diplexer for multifunction antennas, circuits 100, 800, and 1400 may be: incorporated into larger packages such as the antenna system and/or the receiver/GPS housings, or they may be packaged as a discrete components. For example, one such component may be attached to the antennas at one end of a coaxial cable and another component to the receiver/GPS components at the other end of the cable.

The operation of the circuit 100 of FIG. 1 will now be considered. Note that the operation of FIG. 8 is identical, the only difference being its shape. A first RF signal having a wavelength of x is introduced at one of the first port or the second port. (If the circuit 100 is being used as a splitter, then the signal is introduced at the second port, and, if it is being used as a combiner, then the signal is introduced in at the first port.) Upon introduction in the circuit, the signal forms a first standing wave in the second transmission portion, thereby preventing the first RF signal from propagating through the second transmission portion and out of the third port. In this embodiment, the first standing wave is formed in the second transmission portion 102 by reflecting the first RF signal at high impedance free end 113 of stub transmission line 107a approximately an odd multiple of a ¼ x wavelength along second stub transmission line 107a, creating a low impedance to first RF signal at intersection 116 of the second transmission line 106a, thereby preventing the first RF signal from propagating out the third port 110. The first RF signal then travels approximately an additional ¼ x wavelength along second transmission line 106a to intersection 103 creating a high impedance to first RF signal thereby preventing the first RF signal from propagating through second transmission path. In so doing, essentially the entire first RF signal is outputted at either the first port (in the case of a splitter) or the second port (in the case of a combiner).

Likewise, either concurrently or at a different time from the introduction of the first RF signal, a second RF signal having a wavelength of y may be introduced at either the third port (in the case of a combiner) or the second port (in the case of a splitter). The combination of the first transmission portion's configuration and the wavelength of the second RF causes a second standing wave to form in the first transmission portion, thereby preventing the second RF signal from propagating through the first transmission portion and out the first port. The second standing wave is formed in the first transmission portion 101 by reflecting the second RF signal at high impedance free end 111 of stub transmission line 105a approximately ¼ y wave length along second stub transmission line 105a creating a low impedance to second RF signal at intersection 117 of the first transmission line 104a thereby preventing the second RF signal from propagating out the first port 108. The second RF signal then travels approximately an additional ¼ y wave length along first transmission line 104a to intersection 103 creating a high impedance to second RF signal thereby preventing the second RF signal from propagating through first transmission path. The second RF signal is thus forced to output the circuit from either the third port (in the case of a splitter) or the second port (in the case of a combiner). Preferably, the first RF signal propagates between the first and second ports without passing through a filter, and the second RF signal propagates between the third and the second ports without passing through a filter.

In one embodiment, the wavelengths of the signals are sufficiently different such that their transmission through the circuit 100 will be sufficiently different as well as to separate the signals. Preferably, the x and y differ by at least ±⅛ x, more specifically, x and y differ by about ±¼ x. In a particular application, y is about 1.5 x. In this embodiment, y may be a GPS wavelength (1.575 GHz) and x may be a SDARS wavelength (2.32-2.34 GHz). The circuit of the present invention operates particularly well at these frequencies since they are essentially spot frequencies, thus lending themselves to the use of narrow band open-ended stubs.

Preferably, the first and second signal are the same type of signal—i.e., either bidirectional or unidirectional. For example, it is preferred to group together two receive-only functions (e.g., SDARS and GPS), and two bi-directional functions (e.g., AMPS and PCS). There may be certain circumstances however which favor grouping different types of signals as shown in FIG. 14.

The operation of the circuit 1400 of FIG. 14 will now be considered. Specifically, a first RF signal having a wavelength of x is introduced at one of the first port or the second port. (If the circuit 1400 is being used as a splitter, then the signal is introduced at the second port, and, if it is being used as a combiner, then the signal is introduced in at the first port.) Upon introduction in the circuit, the signal forms a first standing wave in the second transmission portion, thereby preventing the first RF signal from propagating through the second transmission portion and out of the third port. In this embodiment, the first standing wave is formed in the second transmission portion 1402 by reflecting the first RF signal at high impedance free end 1431 of transmission line 1435, creating a low impedance to first RF signal at intersection 1437 of transmission line 1434. The first RF signal then travels approximately an additional odd multiple of ¼ x wavelength along transmission line 1434 to intersection 1443 creating a high impedance to first RF signal thereby preventing the first RF signal from propagating through second portion 1402 to the third port 1410. In so doing, essentially the entire first RF signal is outputted at either the first port (in the case of a splitter) or the second port (in the case of a combiner). Note that the operation of circuit 1400 with respect to the first signal is similar to that of circuit 100 described above. The difference between these circuits is with respect to the propagation of signals in the first portion 1401 which presents high impedance for the second and third signals.

Either concurrently or at a different time from the introduction of the first RF signal, a second and third RF signals having wavelengths y, z may be introduced at either the third port (in the case of a combiner) or the second port (in the case of a splitter). The combination of the first transmission portion's configuration and the wavelength of the second and third RF signals causes second and third standing waves, respectively, to form in the first transmission portion 1401, thereby preventing the second and third RF signals from propagating through the first transmission portion and out the first port 1408.

The second standing wave is formed in the first transmission portion 1401 by reflecting the second RF signal at high impedance free end 1411 of transmission line 1415, creating a low impedance to second RF signal at intersection 1417 of the first transmission line 1414. The second RF signal then travels along transmission line 1414 to intersection 1443 creating a high impedance to second RF signal, thereby preventing the second RF signal from propagating through first transmission portion 1401. The second RF signal is thus forced to output the circuit from either the third port (in the case of a splitter) or the second port (in the case of a combiner).

The third standing wave is formed in the first transmission portion 1401 by reflecting the third RF signal at high impedance free end 1421 of transmission line 1425, creating a low impedance to third RF signal at intersection 1427 of transmission line 1424. The third RF signal then travels approximately an additional ¼ wavelength z along first transmission line 1424 to intersection 1443, creating a high impedance to third RF signal and thereby preventing the third RF signal from propagating through first portion 1401. The third RF signal is thus forced to output the circuit from either the third port (in the case of a splitter) or the second port (in the case of a combiner).

In this embodiment, x may be a GPS wavelength (1575 MHz), y may be an AMPS wavelength (824-894 MHz), and z may be a PCS wavelength (1850-1990 MHz). In such an embodiment, the length of transmission line 1425 is preferably a higher order odd multiple of ¼ wavelength of wavelength z—i.e., ¾ and higher. Higher odd multiples are preferred for narrowing the frequency range of signals having low impedance at intersection 1427. That is, if the signals between which a given transmission portion must distinguish are relatively close in wavelength, it may be preferable to use higher order odd multiple in order to improve the selectivity of the transmission line. In this case, the wavelength of the GPS and PCS signals are relatively close. Therefore, to ensure only PCS signals form standing waves in the first transmission portion 1401, a ¾ multiple of the wavelength of the PCS signal is used. Likewise, on the second transmission portion, the transmission line 1435 is a higher-order odd multiple of a quarter wavelength of the GPS signal wavelength—i.e., ¾ wavelength. Again, this increases the selectivity of the transmission line 1435 so that only the GPS signal forms a standing wave in the second transmission portion 1402.

The circuit of the present invention operates particularly well at these frequencies since they are essentially spot frequencies, thus lending themselves to the US.

### EXAMPLES

The following simulations show the ability of the circuit of the present invention to combine/split signals based on the propagation characteristics of signals having different wavelengths within the same circuit without the need for filters or other discrete components.

### Example 1

Based on the principles of the present invention described above, a combiner/splitter circuit shown in FIG. 1 was designed and optimized using Ansoft Designer™ software on a 30 mil thick, εr=3.2, tan δ=0.003 substrate. Care was taken during the design process to minimize size, discontinuities, and insertion loss making appropriate trade-offs were necessary.

Because the microstrip lines connecting the ports must also carry DC current, wider 50Ω lines were used. Narrower higher impedance lines could have been used due to the narrow operating bandwidth for compactness, but this does more to increase insertion loss and limit the DC current capacity.

The open stubs were kept as straight as practically possible to maximize their effective Q but sufficiently spaced from, the 50Ω lines to minimize coupling. Their stub impedances were kept intentionally high, 120Ω, to minimize conductor and substrate losses and also minimize out of band loading of the 50Ω lines.

With the layout complete, the stub and transformer lengths were simultaneously optimized using the optimization engine within Ansoft Designer™. The optimization goal was set for S21 and S23 equal to zero. The optimized final layout is shown in FIG. 1 with the GPS and SDARS inputs on ports 110 and 108 respectively. The overall dimension of the layout is 27 mm×20 mm.

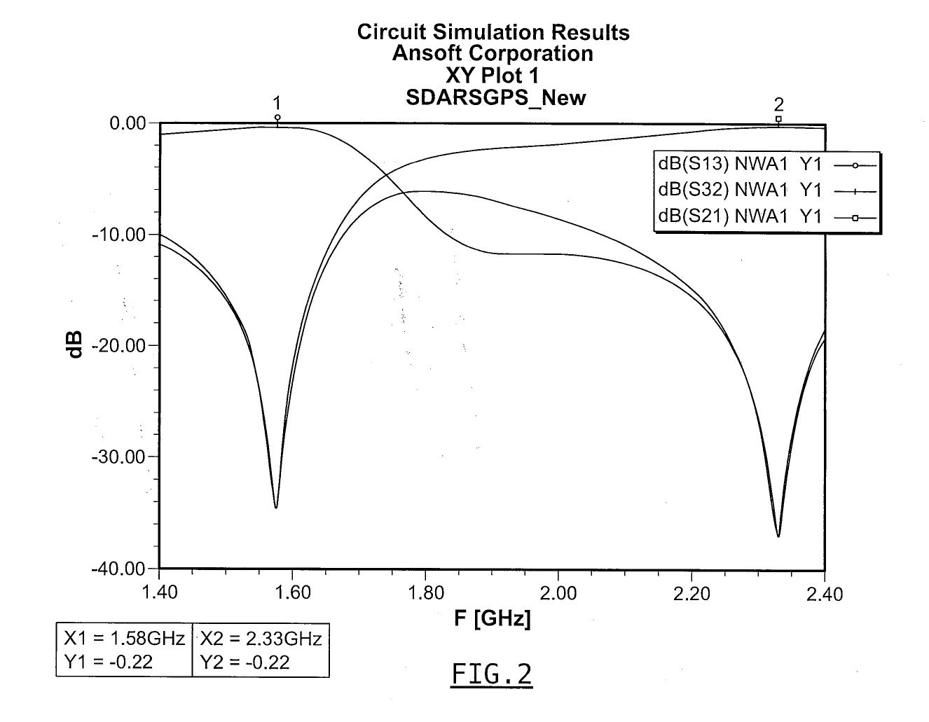

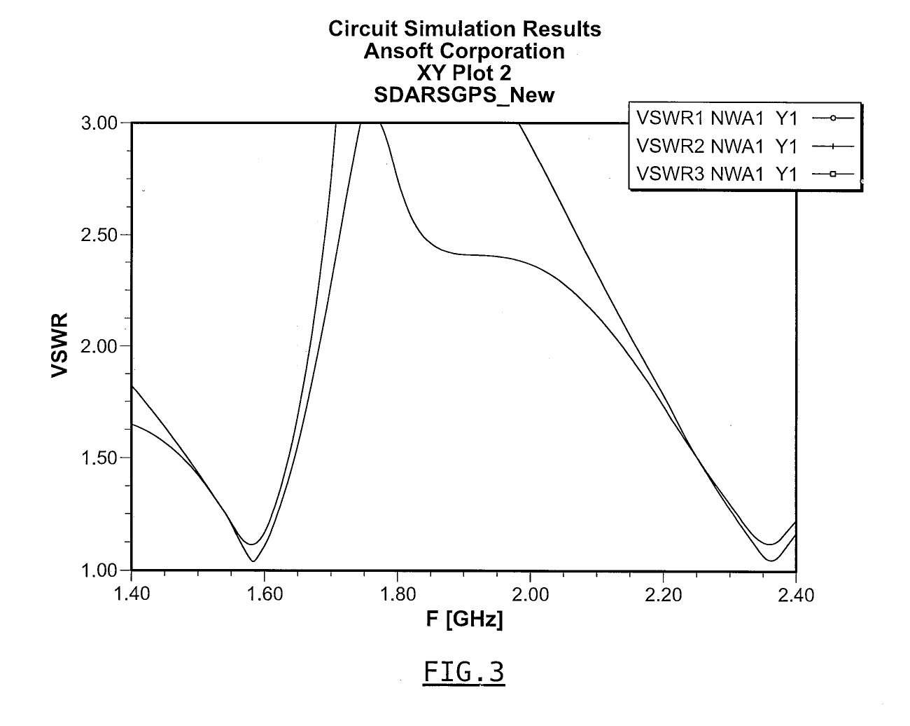

1 GHz to 2 GHz swept frequency circuit simulation was conducted to show the optimized network performance. These results indicate an equal insertion loss of 0.22 dB and more than 20 dB isolation as shown in FIG. 2. The VSWR plot is shown in FIG. 3.

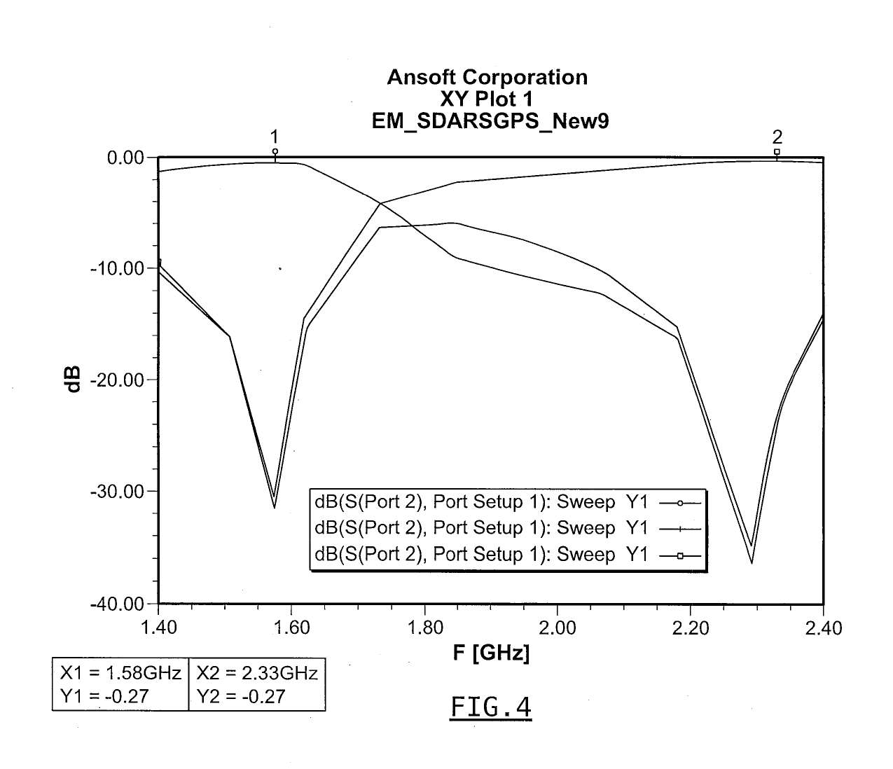

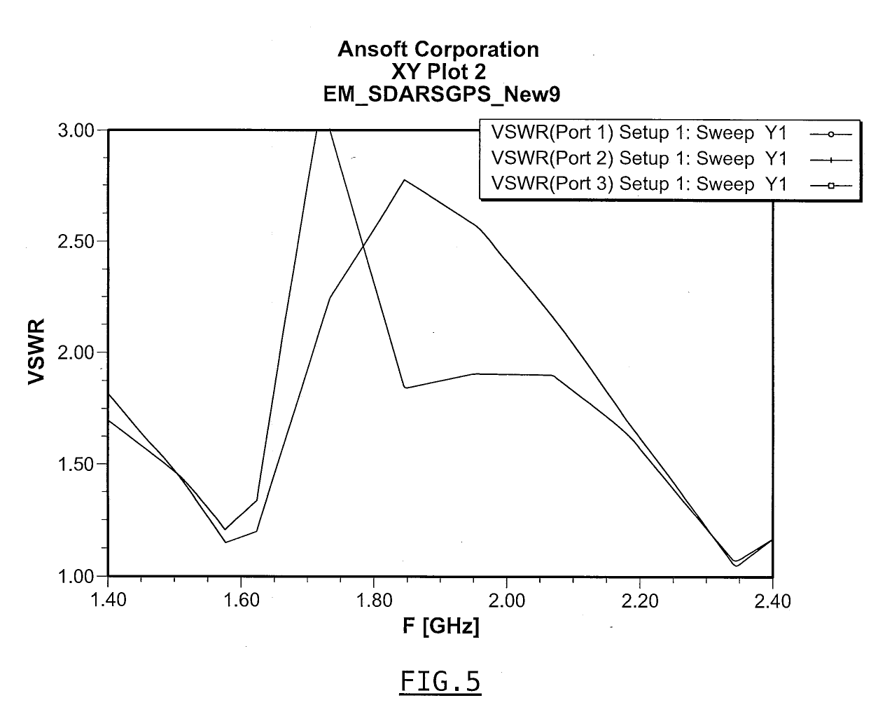

Although these results shown an impressive level of isolation, the circuit model used in the simulation did not have the necessary elements to account for coupling. To investigate any possible coupling between the stubs and the transformers, the 2.5D FEM (finite element modeling) simulator also built into Ansoft's Designer™ was utilized. The 2.5D FEM results are shown in FIGS. 4 and 5. As shown, the circuit and 2.5D FEM simulations agree very well and indicate little to no coupling exists between the stubs and transformers. Specifically, as shown in FIG. 4, there is an insertion loss of 0.27 dB for both marker 1 (GPS port) and marker 2 (SDARS port). The SDARS port isolation at GPS frequency is about 30 dB, while the GPS port isolation at SDARS frequency is about 22 dB.

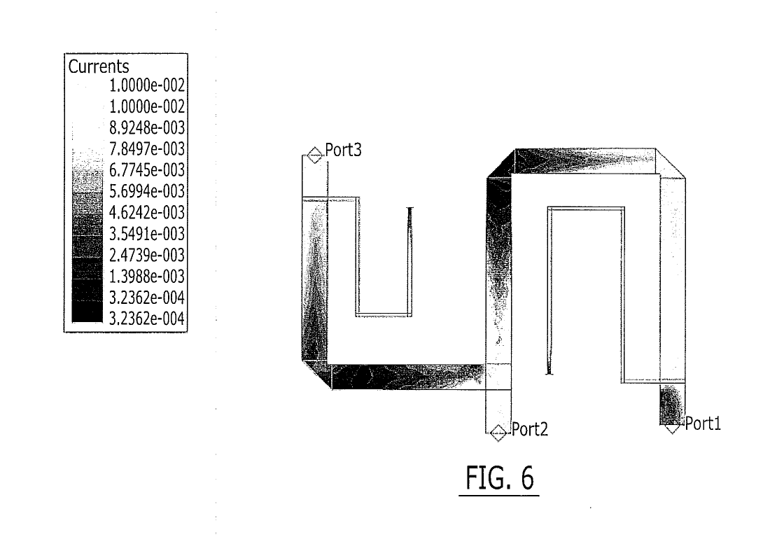

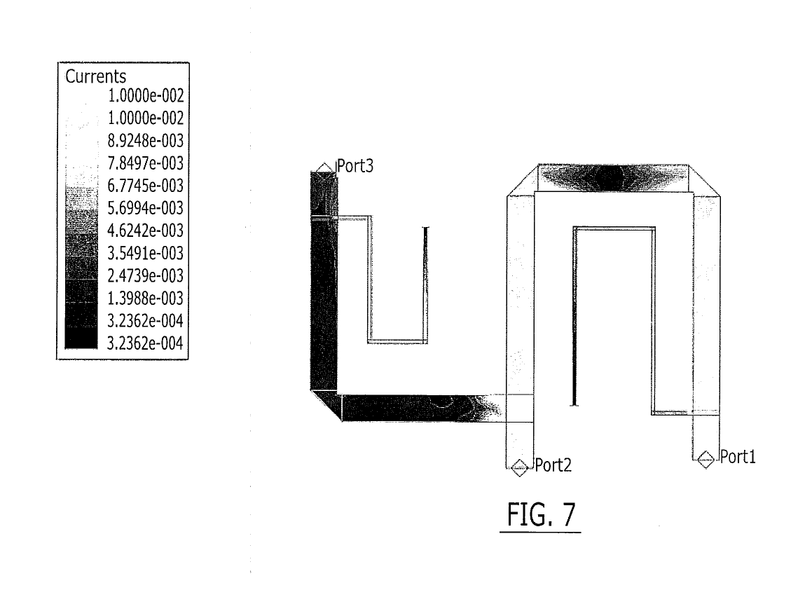

Furthermore, FIGS. 6 and 7 show the current distribution on the network at 1.575 GHz and 2.333 GHz respectively. As shown, in FIG. 6, when the 1.575 GHz signal is applied to the second port, there is very little current flow, indicated by dark region, at the first port while the second and third ports have high current, bright regions indicating that most of the signal is exiting the third port. Likewise, referring to FIG. 7, when the 2.333 GHz signal is applied to the second port, there is very little current flow at the third port and high current flow at the first port indicating that most of the signal is exiting the first port.

### Example 2

A combiner/splitter circuit having the configuration shown in FIG. 8 was designed and optimized using the same software and design parameters as in Example 1 except obviously for geometry.

A 1 GHz to 2 GHz swept frequency circuit simulation and 2.5D FEM simulation were conducted to show the optimized network performance. The 2.5D FEM shown in FIG. 9 insertion loss of 0.75 dB for marker 1 (GPS port) and 0.59 dB for marker 2 (SDARS port). The SDARS port isolation at GPS frequency is about 23 dB, while the GPS port isolation at SDARS frequency is about 28 dB.

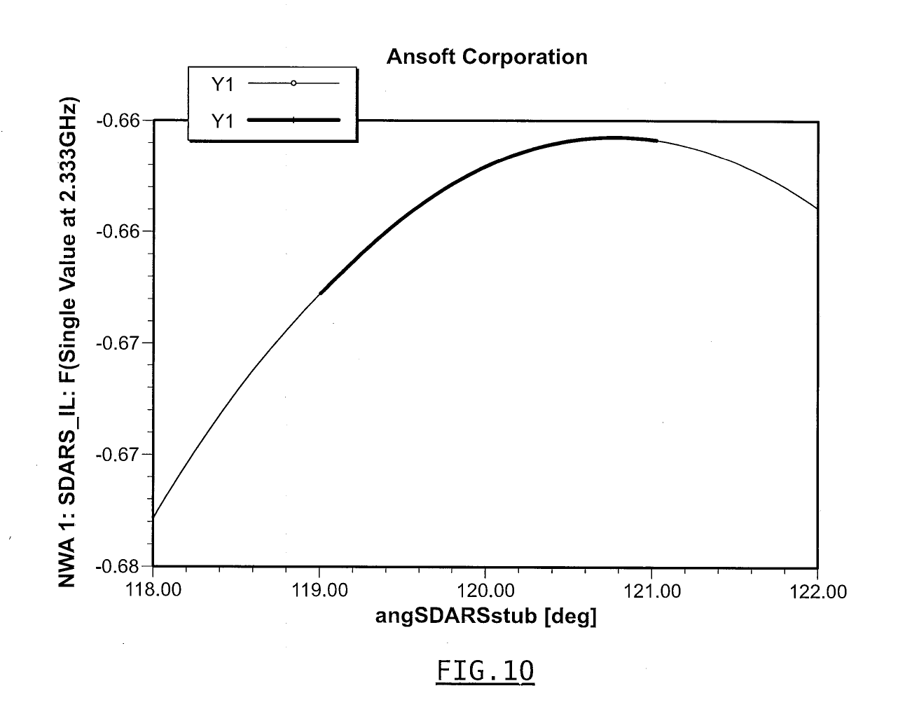

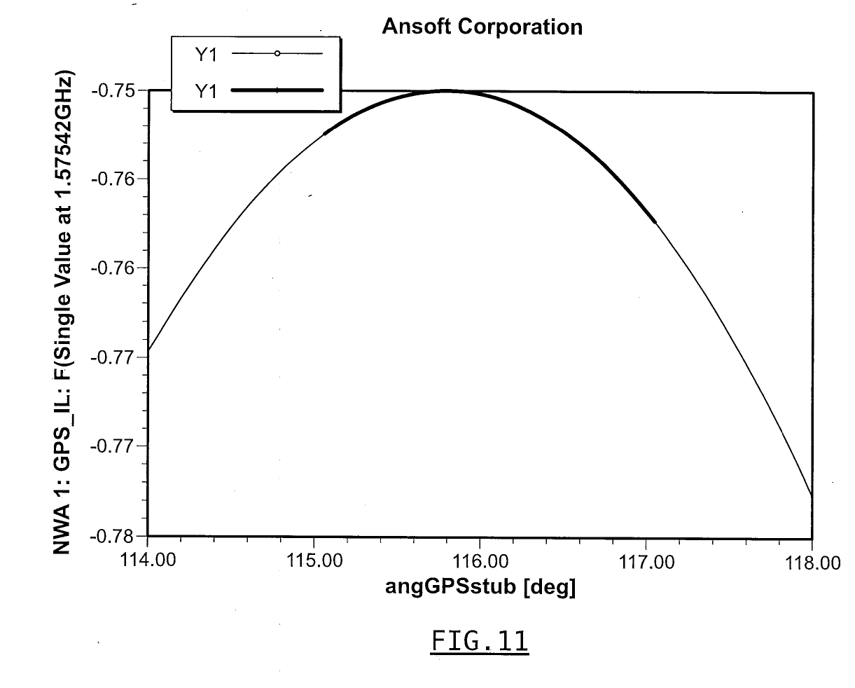

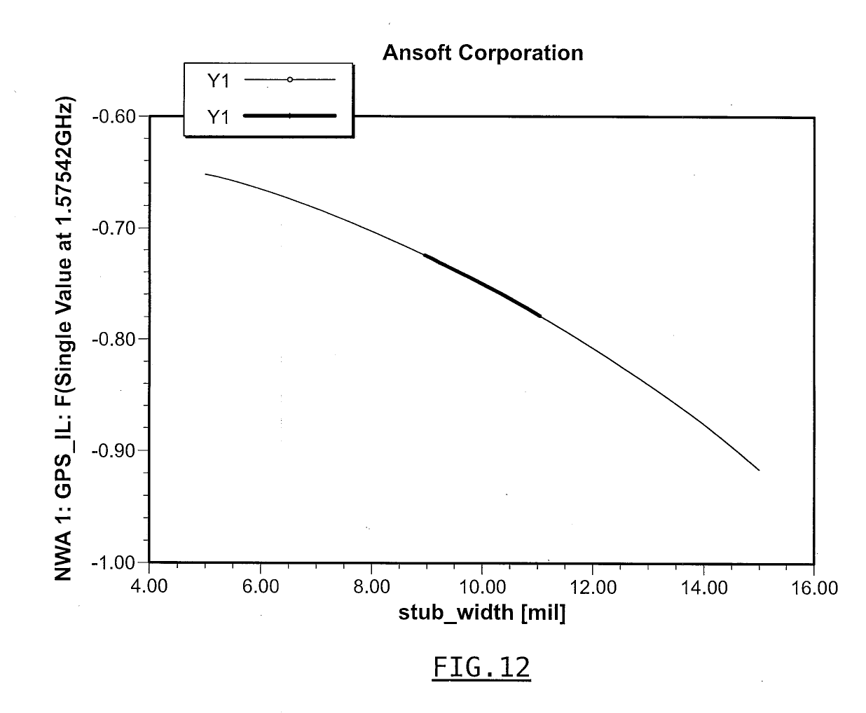

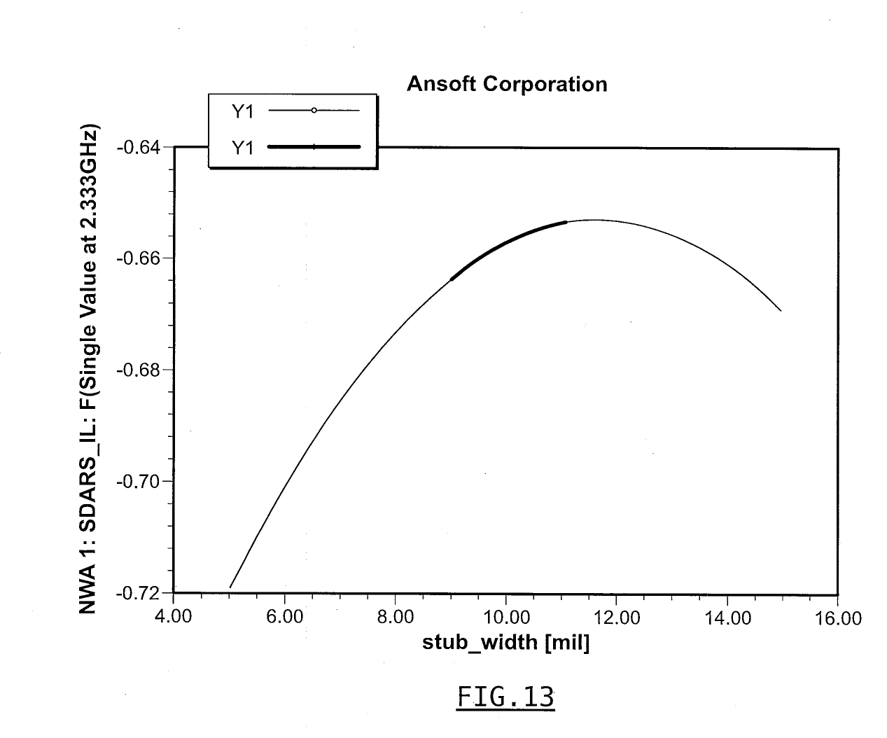

FIGS. 10-13 show the manufacturing tolerances afforded by the configuration of FIG. 8. Referring to FIGS. 10 and 11, the tolerance in the length of the arc of the SDARS and GPS stubs is shown, respectively. In each case, a deviation of ±2 degrees from the center nominal angle (i.e., 240° and 232°, respectively) does not have a significant effect on the insertion loss. Referring to FIGS. 12 and 13, the width of the stubs can range ±1 mil from the nominal width (i.e., 10 mils for each) without significantly affecting insertion loss. The tolerance in the length and width of the stubs indicates a high degree of manufacturability of this circuit design.

### Example 3

A combiner/splitter circuit having the configuration shown in FIG. 14 was designed and optimized using the same software and design parameters as in Example 1 except obviously for geometry.

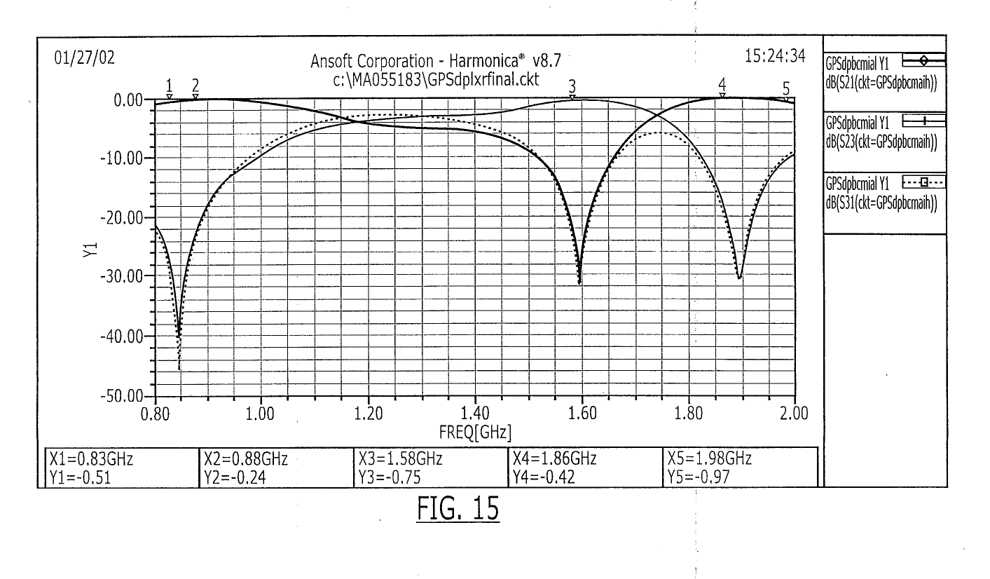

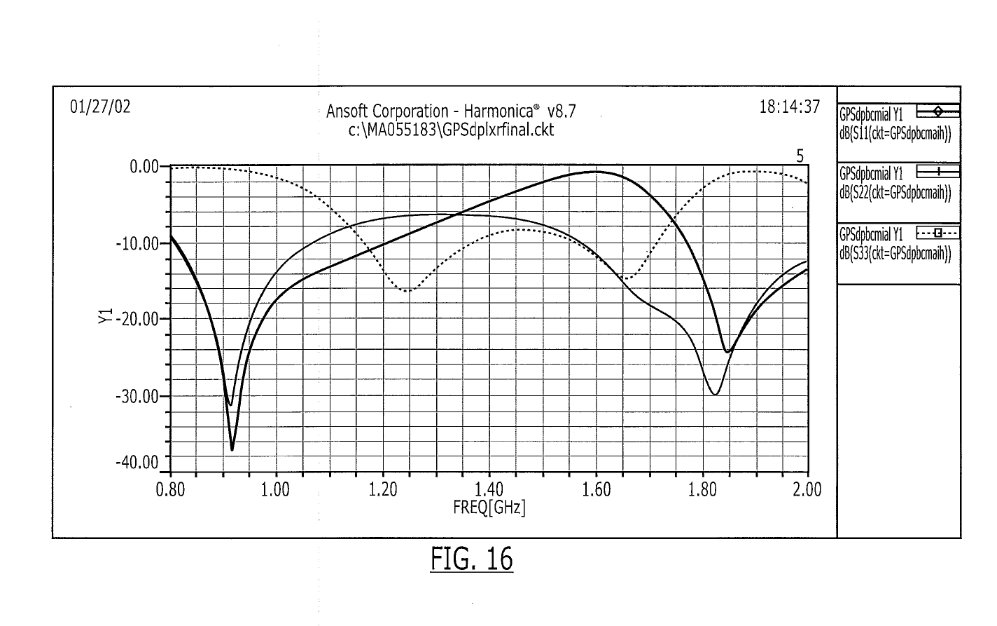

A 0.8 GHz to 2 GHz swept frequency circuit simulation and 2.5D FEM simulation were conducted to show the optimized network performance. The circuit simulation insertion loss and isolation results are shown in FIG. 15. The insertion loss values at specific frequencies are indicated by markers one through five. Markers one and two are placed at the AMPS band edges and show an insertion loss of 0.51 dB and 0.24 dB respectively at the AMPS/PCS port. Marker three indicates a 0.75 dB insertion loss at the GPS port. Makers four and five are placed at the PCS band edges and show an insertion loss of 0.42 dB and 0.97 dB respectively. The AMPS/PCS port to GPS port isolation results are shown in the green trace of FIG. 15. The minimum AMPS to GPS isolation is approximately 25 dB, minimum AMPS/PCS to GPS isolation is also approximately 25 dB, and the minimum PCS to GPS isolation is approximately 10 dB. The circuit simulation return loss results are shown in FIG. 16 and indicate each port is well matched having a minimum return loss of 10 dB within their respective frequency bands.

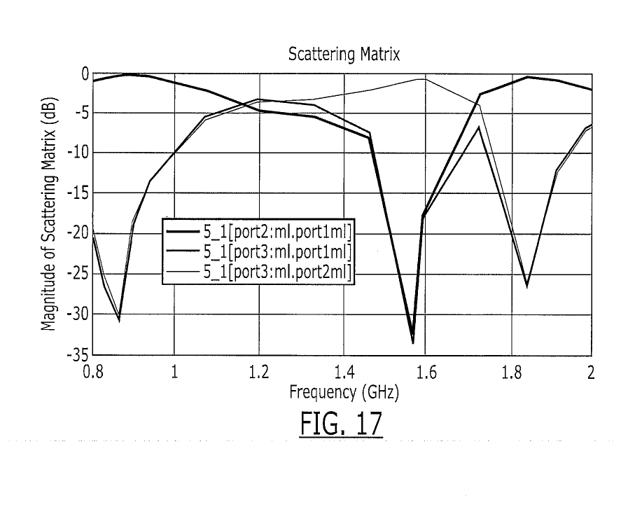

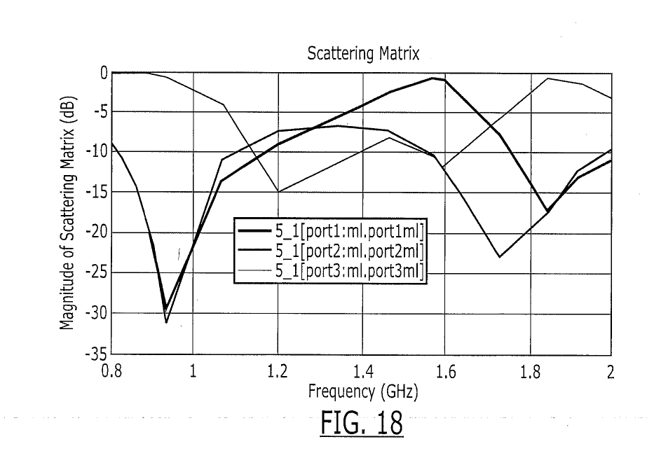

Because the circuit simulation does not account for the possibility of mutual coupling between the stubs and transmission lines, a 2.5D FEM simulation is necessary. The 2.5D FEM results shown in FIGS. 17 and 18 are in excellent agreement with the circuit simulation results, indicating little to no mutual coupling exists despite the relatively small circuit size.

What is claimed is:

1. A circuit for combining/splitting at least two RF signals, each having different wavelengths, said circuit comprising:
at least two or more transmission portions coupled at an intersection, said intersection having a common port for inputting or outputting a combination of said at least two RF signals;
each transmission portion extending from said intersection to a port for inputting or outputting a selection of signals from said combination, and comprising at least one set of intersecting transmission lines;
each set of intersecting transmission lines rejecting a particular signal of said combination;
each intersecting transmission line of a given set having a length of about an odd multiple of a quarter wavelength of the particular signal which is rejected by said given set.

2. The circuit of claim 1, wherein at least two transmission portions comprises two transmission portions, and said at least two signals comprise two signals.

3. The circuit of claim 1, wherein the selection of signals comprises just one signal at each port.

4. The circuit of claim 3, wherein said two signals are GPS and SDARS, said GPS being the particular signal rejected by one transmission portion, and SDARS being the particular signal rejected by the other transmission portion.

5. The circuit of claim 1, wherein at least two transmission portions comprise three transmission portions and said at least two signals comprises three signals.

6. The circuit of claim 5, wherein the selection of signals comprises just one signal at each port.

7. The circuit of claim 1, wherein at least two transmission portions comprise two transmission portions and said at least two signals comprises three signals.

8. The circuit of claim 1, wherein the selection of signals comprises one signal at the port of one of said transmission portions, and two signals at the port of the other transmission portion.

9. The circuit of claim 8, wherein said three signals comprise GPS, AMPS and PCS, one transmission portion comprising two sets of intersecting transmission lines to reject AMPS and PCS and the other transmission portion comprising one set of transmission lines to reject GPS.

10. A circuit for combining/splitting at least a first, second, and third RF signals having different wavelengths x, y, and z, respectively, said circuit comprising:
at least first and second transmission portions coupled at an intersection, said first transmission portion comprising at least first and second sets of intersecting transmission lines, said first set comprising two intersecting transmissions lines, each having a length of about an odd multiple of ¼ y, said second set comprising two intersecting transmissions lines, each having a length of about an odd multiple of ¼ z, said second transmission portion comprising at least at third set of intersecting transmission lines, said third set comprising two intersecting transmissions lines, each having a length of about an odd multiple of ¼x; and
first, second and third ports, said first port being located at a distal end of said first transmission portion, said second port located at said intersection of said first and second transmission portions, and said third port being located at a distal end of said second transmission portion.

11. The circuit of claim 10, wherein said first and second transmission portions are devoid of a filter.

12. The circuit of claim 10, wherein each set of intersecting transmission lines comprises at least:
a main transmission line running from said intersection to a second intersection; and
a stub transmission line having a free end and a connected end, said connected end of said stub transmission line being connected to said second intersection.

13. The circuit of claim 12, wherein one or more main transmission lines or one or more stub transmission lines comprise two or more portions at an angle to one another.

14. The circuit of claim 12, wherein one or more main transmission lines or one or more stub transmission lines are curved.

15. The circuit of claim 10, wherein at least one of said first or second transmission portions comprises a capacitor to block DC current from being conducted therethrough.

16. The circuit of claim 10, wherein the characteristic impedance of said main transmission lines is lower than that of said stub transmission lines.

17. The circuit of claim 10, wherein x, y, and z are GPS, AMPS, and PCS wavelengths, repetitively.

18. The circuit of claim 10, wherein said second transmission portion comprises a fourth set of intersecting transmission lines, said fourth set comprising two intersecting transmissions lines, each having a length of about an odd multiple of ¼ z, and wherein said circuit further comprises a third transmission portion having a fourth port, and comprising fifth and six sets of intersecting transmission lines, said fifth set comprising two intersecting transmissions lines, each having a length of about an odd multiple of ¼ x, said sixth set comprising two intersecting transmissions lines, each having a length of about an odd multiple of ¼ y.
